(19) United States
(12) Patent Application Publication
(10) Pub. No.: US 2019/0026273 A1
(43) Pub. Date: Jan. 24, 2019

(54) ALIAS COMMUNICATION

(71) Applicant: CELL BUDDY NETWORK LTD., Tel Aviv (IL)

(72) Inventors: Ofir PAZ, Rishon LeZion (IL); Erez DORON, Tel Aviv (IL); Eyal ARBABOF, Salit (IL)

(21) Appl. No.: 15/758,350

(22) PCT Filed: Sep. 9, 2016
(86) PCT No.: PCT/IB16/55388

§ 371 Date: Mar. 8, 2018

Related U.S. Application Data
(60) Provisional application No. 62/216,047, filed on Sep. 9, 2015.

(51) Int. Cl. G06F 17/30; G06T 13/40; G06F 21/31

(52) U.S. Cl. CPC G06F 17/30029; G06F 2221/2117; G06F 21/31; G06T 13/40

(57) ABSTRACT

A method for a user to interact with a computer-based functionality as one of a plurality of virtual personas (“VPs”), the method comprising: registering a user's selection of one VP out of a plurality of VPs associated with the user, each VP comprising characterizing information characterizing one of a plurality of aspects of the user, the selected VP being operable to be controlled by the user to configure an instruction to the functionality; receive the instruction and forward the instruction to the functionality; receive a response responsive to the instruction from the functionality; and forward the response to the user.

### RELATED APPLICATIONS

The present application is a US National application, which claims the benefit of under 35 U.S.C. § 119(e) of U.S. Provisional application 62/216,047 filed on Sep. 9, 2015.

### TECHNICAL FIELD

Embodiments of the invention relate to a method of computer-based search and/or communication.

### BACKGROUND

An individual may have diverse aspects to himself or herself and disparate areas of interest. However, many computer-based functionalities such as communication or search are designed to have one account for given user.

### SUMMARY

An aspect of an embodiment of the disclosure relates to providing a user of a computing device with a method for interacting with a computer-based functionality as one of a plurality of virtual personas (which may be referred to herein as a “VP”). Each VP comprises “VP elements” that characterize an aspect of the user's character, interests and/or identity that the user wishes to be presented to the computer-based functionality.

For convenience of presentation, a user that is associated with a given VP may be referred to as a “master” of the given VP. Each user may be a master of a plurality of VPs. The plurality of VPs associated with a given VP master may be referred to herein as the given VP master's “VP set”. A given VP selected from a VP set for interacting with a computer-based tool may be referred to herein as an “activated VP”, while non-selected VP's of the VP set may be referred to herein as “non-activated VPs”. VPs that share a same VP master may be referred to as “siblings”.

In an embodiment of the invention, the computer-based functionality may be responsive to VP elements of an activated VP. In an embodiment of the invention, the computer-based functionality may be responsive to VP elements of siblings of the activated VP.

In an embodiment of the disclosure, the computer-based functionality may be an application, an API or a website. In an embodiment of the disclosure, the computer-based functionality may be a search engine. Optionally, the search engine is for a first VP master to identify, from a plurality of VPs, a second VP master's VP comprising a desired VP element. For clarity of presentation, the method in accordance with an embodiment of the disclosure where the computer-based functionality is a search engine may be referred to herein as a “persona-based search”.

In an embodiment of the disclosure, following identification of a desired VP, the first VP master may initiate a computer-based communication with the second VP master.

In an embodiment of the disclosure, each VP may be anonymous, in that while VP elements of a given VP may be accessible to another VP, another VP master, or a computer-based functionality, the identity of a VP master and/or sibling VPs of a given VP may not be accessible. Alternatively or additionally, VP elements comprised within the given VP may be lacking sufficient information, or may contain incorrect information, such that others accessing the given VP cannot identify a VP master and/or sibling VPs based on the VP elements comprised within the given VP.

In the discussion, unless otherwise stated, adjectives such as “substantially”, “relatively” and “about” modifying a condition or relationship characteristic of a feature or features of an embodiment of the invention, are understood to mean that the condition or characteristic is defined to within tolerances that are acceptable for operation of the embodiment for an application for which it is intended. Unless otherwise indicated, the word “or” in the specification and claims is considered to be the inclusive “or” rather than the exclusive or, and indicates at least one of, or any combination of items it conjoins.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF FIGURES

Non-limiting examples of embodiments of the invention are described below with reference to figures attached hereto that are listed following this paragraph. Identical structures, elements or parts that appear in more than one figure are generally labeled with a same numeral in all the figures in which they appear. Dimensions of components and features shown in the figures are chosen for convenience and clarity of presentation and are not necessarily shown to scale.

FIG. 1 schematically illustrates a computer system that enables a persona-based search in accordance with an embodiment of the invention; and

FIGS. 2-4 shows flowcharts for persona-based search methods in accordance with embodiments of the disclosure.

### DETAILED DESCRIPTION

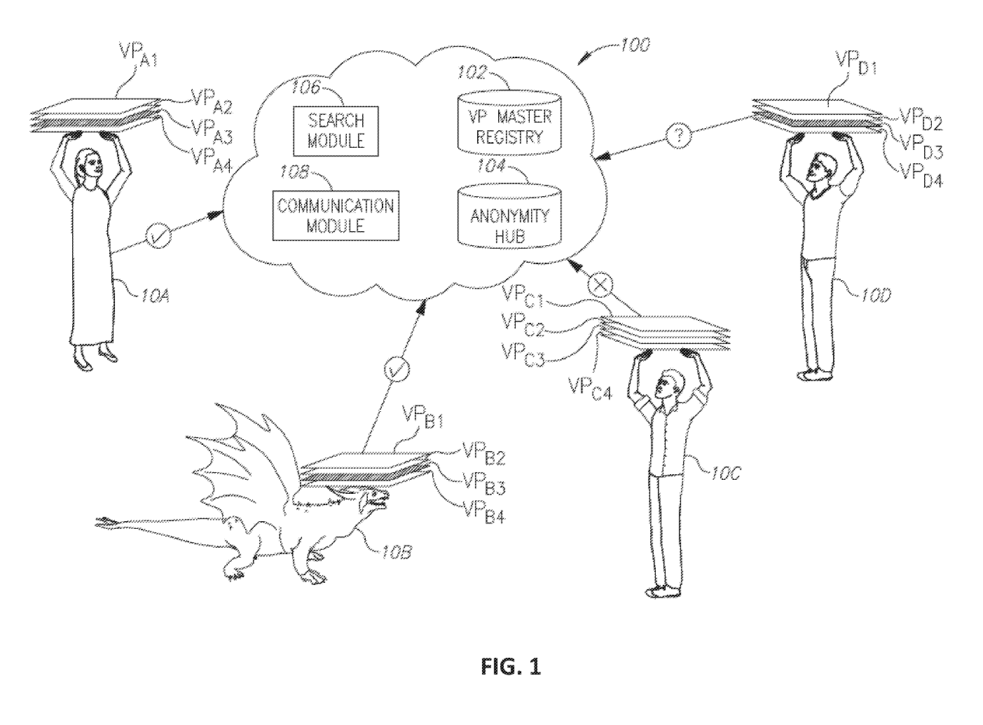

FIG. 1 schematically illustrates a computer system 100 in accordance with an embodiment of the disclosure, which may be referred herein to as a persona control and management system (“PCMS”). PCMS 100 may be utilized by a plurality of VP masters 10A-10D to access a computer based functionality, such as applications and/or websites as one of a plurality of VPs. A given VP master may access and interact with PCMS 100 through a computing device (not shown), by way of example, a desktop computer, a laptop computer, a tablet, and a smartphone.

Each VP comprises a set of VP elements that characterizes a persona that the master of the VP desires to present to the public. VP elements may include any aspect of the VP master that the VP master wishes to present in the context of a given VP, for example, a hobby, a profession, sex, age, a geographical location, or an interest. In an embodiment of the disclosure, VP elements may include a use history of the given VP with one or more computer-based functionalities. By way of example, the use history may be a search history, a browsing history, or a communication log. At least one VP element may be an ID that is unique from all other VPs comprised in PCMS 100.

Each VP associated with a given VP master is schematically represented in FIG. 1 as a card held above the associated master's head. As schematically shown in FIG. 1, VP master 10A (schematically represented as a woman) is associated with four VPs, VP_{A1}-VP_{A4}, VP master 10B (schematically represented as a dragon) is associated with four VPs, VP_{B1}-VP_{B4}, VP master 10C (schematically represented as a frowning man) is associated with four VPs, VP_{C1}-VP_{C4}, VP master 10D (schematically represented as a smiling man) is associated with four VPs, VP_{D1}-VP_{D4}. Whereas each VP master is shown as being associated with four VPs, a given VP master may be associated with as many VP that the given VP creates or is created for him by others.

By way of example, VP master 10D may create VPs that reflects his interests. VP_{D1} may be named “Cycling” and contain VP elements reflecting VP master 10D's cycling hobby, such as a personal statement describing his interest in cycling, a list of bicycles he owns, a riding log, and a competition record. The Cycling VP may further comprise a query for upcoming charity rides and/or for a riding partner. VP master 10D may be conscientious to limit his internet browsing and searches to cycling-related topics when the Cycling VP is activated, so that the browsing and search histories comprised in VP_{D1} reflect his interest in cycling. VP_{D2} may be named “Japan” and contain VP elements reflecting VP master 10D's interest in Japanese culture, such as a personal statement describing his travels to Japan and his knowledge of the Japanese language, a record of Japanese books he has read and locations in Japan he has visited. VP Master 10D may be conscientious to limit his internet browsing and search to Japan-related or Japan-language websites when the Japan VP is activated, so that the browsing and search histories comprised in VP_{D2} reflect his interest in Japan. The Cycling and Japan VPs will be referred to hereinbelow to provide additional examples.

PCMS 100 in accordance with an embodiment of the disclosure may comprise an anonymity hub, schematically represented as a cylinder 104, that comprises a record of VPs created by and/or for the VP masters, and a VP master registry, schematically represented as a cylinder 102, comprising a lookup table associating a given VP with a given master. Optionally, VP master registry 102 comprises a confidential profile for VP masters that have records of VPs in anonymity hub 104. The confidential profile may comprise confirmation information on the associated VP master, by way of example, any or a combination of a legal name, bank account information, credit card information, phone number, street address, and email address. In an embodiment of the disclosure, VP master registry 102 is used by PCMS 100 for forwarding information between a given VP comprised in anonymity hub 104 and a master VP associated with the given VP. However, a VP master interacting with PCMS 100 cannot access VP master registry 102. As such, in an embodiment of the disclosure, a given VP master cannot access the confidential profile of another VP master through PCMS 100.

PCMS 100 may comprise or be operationally connected to a computer-based functionality. In an embodiment of the disclosure, the computer-based functionality is a search module 106 that communicates with anonymity hub 104 to perform a persona-based search, as detailed hereinbelow. The persona-based search may be used to search for, by way of example, the internet or VPs comprised in PCMS 100. In an embodiment of the disclosure, the computer-based functionality may be a communication module 108 for a first VP master, as a selected VP, to anonymously communicate with another VP. Communication between VPs may be mediated through voice, text or video. In an embodiment of the disclosure, communication module 108 connects a VP to another VP, and does not provide information beyond what is available from the VP elements comprised in the VPs active in the communication. By way of example, when two VPs communicate through communication module 108, the VP name of each VP may be visible to the participants, but confidential information such as a legal name or a phone number may not be accessible to the participants.

FIG. 1 illustrates an exemplary result of a search conducted by VP master 10D for other VPs of interest to him. By way of example, he may select one of a plurality of his associated VPs, VP_{D3}, through which to conduct the search for VPs of doctors. Through the search, VP master 10D indentifies two VPs, VP_{B3} associated with VP master 10B and VP_{A3} associated with VP master 10A, that comprise a VP element indicating that the master of the respective VP is a doctor.

PCMS 100 may comprise a remote computer system. The remote computer system may optionally be a remote server or a remote distributed system. The remote distributed system may be referred to herein as a “cloud computer system.”

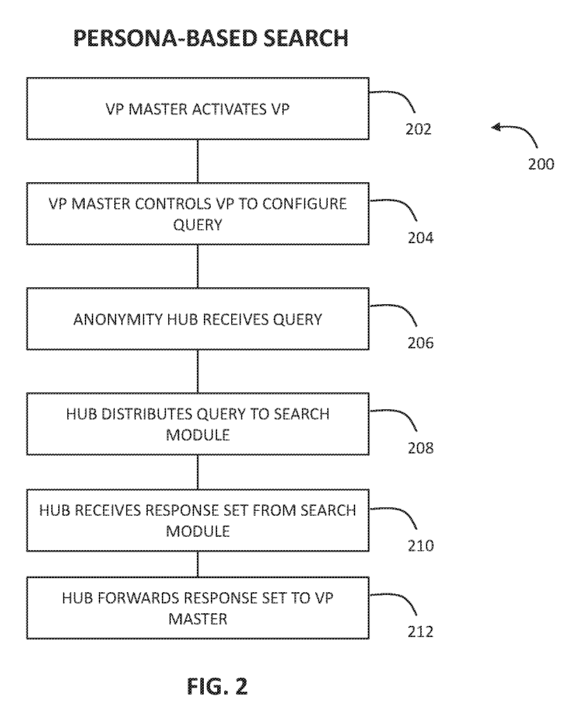

Reference is now made to FIG. 2, showing a flowchart of a persona-based search method 200 in accordance with an embodiment of the invention. Persona-based search method 200 is described hereinbelow, by way of example, as being conducted through PCMS 100 shown in FIG. 1.

In an embodiment of the invention, in block 202 of persona-based search method 200, a VP master selects a VP from a plurality of VPs associated with the VP master and stored in anonymity hub 104. By way of example, the VP master selects a desired VP through a drop down menu and/or typing in an ID of the desired VP, by way of example a name or an ID number. Optionally, a VP may be a “secret VP” that does not appear in a drop down menu but is selectable by typing in the ID of the secret VP.

Following activation of a desired VP, the VP master in block 204 controls the activated VP to configure a query for search module 106, and, in block 206, anonymity hub 104 receives the configured query associated with the activated VP. Optionally, the VP master manually enters a query following VP activation. Optionally, a VP element comprised in the activated VP is a query, and activation of the VP triggers the query to be configured for the search engine. In block 208, anonymity hub 104 distributes the query to search module 106, and then receives, in block 210, a response set from search module 106 comprising a plurality of search results. Anonymity hub 104 then forwards the response set, responsive to VP master registry 102, back to the VP master associated with the activated VP through which the search was conducted.

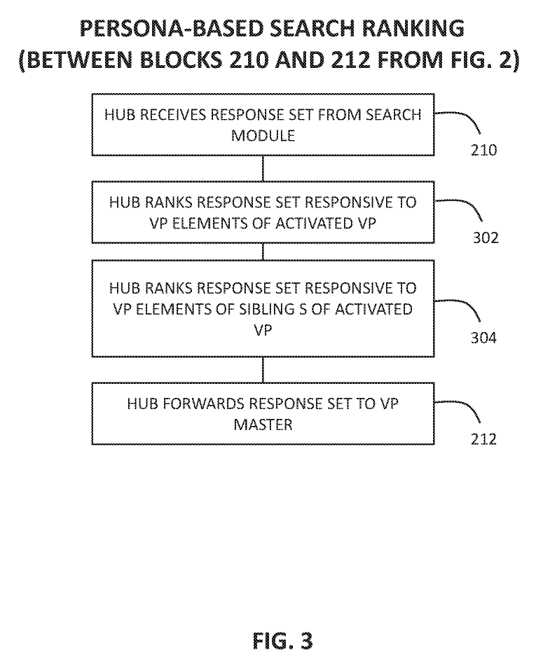

Reference is now made to FIG. 3. Search results are typically ranked responsive to a variety of factors, such as on how well-matched a given search result is to terms in the query. In an embodiment of the invention, once a response set is received by anonymity hub 104 from search module 106 (block 210), the hub adjusts the ranking of the returned response set responsive to VP elements of the activated VP (block 302). Where the search is a website search, each search result is evaluated on how well content and/or metadata of the website matches one or more VP elements, and websites that are better matched to the VP elements of the activated VP gets ranked higher in accordance with a first weighing factor.

By way of example, VP master 10D activates his Cycling VP (VP_{D1} as described hereinabove) and searches for recent fiction bestseller novels. After anonymity hub 104 receives a results set comprising internet links for recent bestsellers, the hub may adjust the ranking of the results set so that links to bestsellers that better match VP elements in the Cycling VP tend to receive a higher adjusted ranking. By way of example, links for bestsellers that is about cycling, and/or take place in locations that match with locations included in the riding log or competition record, and/or match entries in browsing and search histories associated with the Cycling VP may have their ranking adjusted higher relative to links that do not have content or metadata that match VP elements in the Cycling VP.

Optionally, the hub further adjusts the ranking of the response set responsive to VP elements of one or more sibling VPs of the activated VP (block 304). Where the search is a website search, websites that are better matched to the VP elements of the sibling VP get ranked higher in accordance with a second weighing factor. Optionally, the second weighing factor is less than the first weighing factor, so that the activated VP influences the rank adjustment more than the sibling VPs.

Continuing with the above example regarding the search for bestsellers, the ranking of the results set is optionally further adjusted responsive to VP master 10D's Japan VP VP_{D2}, which is a sibling of Cycling VP VP_{D1}. Links for bestsellers that are about Japan, or take place in locations in Japan that VP master 10D has visited, or have a same author as a Japanese book VP master 10D has read, will tend to have its ranking adjusted higher relative to links that do not have content or metadata that matches VP elements comprised in the Japan VP. As a result, a link having content or metadata that matches VP elements from both the Cycling VP and Japan VP may have its ranking adjusted to a higher degree compared to links that match VP elements from only one of the VPs.

Once the rank adjustment is complete, the response set is forwarded to and displayed in a computer device operated by the VP master (block 212). Optionally, the VP master views the response set and selects a link to follow.

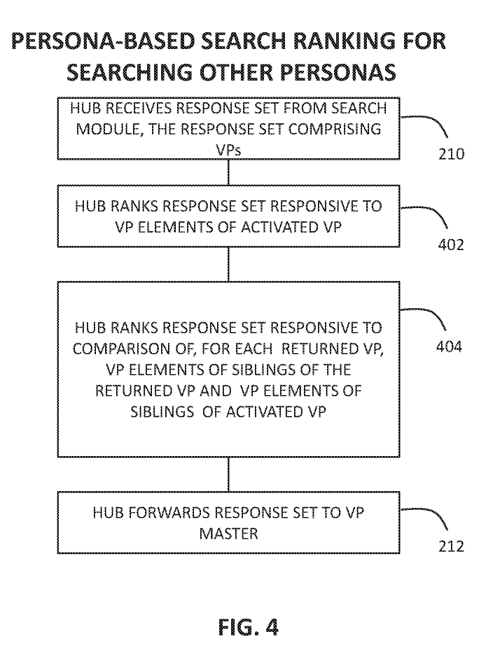

Reference is now made to FIG. 4. Persona-based search method 200 in accordance with an embodiment of the disclosure may be a search for other VPs comprised in anonymity hub 104. Once a response set comprising VPs is returned from search module 106 and received by anonymity hub 104 (block 210), the hub may adjust the ranking of the returned VPs responsive to VP elements of the activated VP (block 402). The VP elements of each returned VP are evaluated on how well they match VP elements of the activated VP, and returned VPs having VP elements that are better matched to the VP elements of the activated VP get ranked higher in accordance with a first weighing factor.

By way of example VP master 10D activates his Cycling VP (VP_{D1} as described hereinabove) and searches for a riding partner. If the Cycling VP already comprises a query for finding a riding partner, the VP master's activation of the Cycling VP may trigger search module 106 to search in anonymity hub 104 for matching VPs, by way of example VPs comprising VP elements, that match the query terms. Alternatively, the VP master may enter the query in a search field after activating the Cycling VP. After search module 106 returns a response set comprising searched VPs, anonymity hub 104 receives the results set and compares VP elements of each of the returned VPs with VP elements of the activated Cycling VP. Responsive to the comparison, the anonymity hub may adjust the ranking of one or more of the returned VPs in the response set so that returned VPs having VP elements that better match VP elements in the activated Cycling VP receive a higher adjusted ranking. By way of example, a given returned VP representing another cyclist seeking a riding partner may have its rank in the response set adjusted higher if the given VP comprises a VP element indicating overlapping locations in its riding log, a same competition in its competition record, or a same model or manufacturer for a bicycle.

Optionally, the hub further compares VP elements of siblings of a given returned VP with siblings of the activated VP, and may adjust the ranking responsive to the results of the comparison (block 404). In an embodiment of the disclosure, a given returned VP with siblings comprising VP elements that are better matched to VP elements comprised in siblings of the activated VP gets ranked higher.

Continuing with the above example regarding the search for a riding partner, the ranking of the results set is optionally further adjusted responsive to comparison between a given returned VP and VP master 10D's Japan VP VP_{D2}, which is a sibling of Cycling VP VP_{D1}, so that a returned VP that has siblings comprising VP elements relating to Japan may tend to have its ranking adjusted higher relative to other returned VPs. By way of example, a returned VP having a sibling comprising VP elements indicating a visit to a same place in Japan, ability to speak Japanese, and/or having read a same Japanese book as indicated in VP master 10D's Japan VP VP_{D2} may have its ranking adjust to a higher rank in the response set.

Once the rank adjustment is complete, the response set is forwarded to and displayed in a computer device operated by the VP master (block 212). Optionally, the VP master views one or more returned VPs comprised in the response set and selects a returned VP to anonymously communicate with, through communication module 108.

There is therefore provided a method for a user to interact with a computer-based functionality as one of a plurality of virtual personas (“VPs”), the method comprising: registering a user's selection of one VP out of a plurality of VPs associated with the user, each VP comprising characterizing information characterizing one of a plurality of aspects of the user, the selected VP being operable to be controlled by the user to configure an instruction to the functionality; receive the instruction and forward the instruction to the functionality; receive a response responsive to the instruction from the functionality; and forward the response to the user.

In an embodiment of the invention, the computer-based functionality may be an application, an API or a website.

In an embodiment of the invention, the functionality may comprise a search engine and the instruction may comprise a query. Optionally, the query is for identifying a VP of another user.

In an embodiment of the invention, the method may further comprising initiating a computer-based communication with the other user of the identified VP.

In an embodiment of the invention, other information relating to the user that is not comprised in the characterizing information of the selected VP is not accessible to the functionality. In an embodiment of the invention, other information relating to the user that is not comprised in the characterizing information of the selected VP is not accessible to another user. Optionally, the other information that is not accessible comprises an identity of the user and/or an identity of other VPs associated with the user.

In an embodiment of the invention, the instruction to the functionality or the response forwarded to the user is modified responsive to the information relating to the user aspect comprised in the selected VP. In an embodiment of the invention, the instruction to the functionality or the response forwarded to the user is modified responsive to information relating to one or more non-selected VPs.

There is also provided a computer system for a user to interact with a computer-based functionality as one of a plurality of virtual personas (“VPs”), the system comprising: a first memory comprising a plurality of VPs, each VP comprising characterizing information that characterizes the VP; a second memory comprising profiles of a plurality of users and association data associating each of the plurality of users with a VP of the plurality of VPs, such that each user is associated with a plurality of VPs and each VP is associated with one user; and a processor operable to: register a user's selection of one VP out the one or more VPs associated with the user, the selected VP being operable to be controlled by the user to configure an instruction to a functionality; receive the instruction and forward the instruction to the functionality; receive a response responsive to the instruction from the functionality; and forward the response to the user.

In an embodiment of the invention, the computer-based functionality is an application, an API or a website. Optionally, wherein the functionality is a search engine and the instruction is a query. Optionally, the query is for identifying a VP associated with another user.

In an embodiment of the invention, the processor is further operable to initiate a computer-based communication with the other user of the identified VP.

In an embodiment of the invention, the user profiles are not accessible to the functionality. Optionally, the user profile of a given user is not accessible to another user.

Optionally, the association data relating to a given user is not accessible to another user.

In an embodiment of the invention, the instruction to the functionality or the response forwarded to the user is modified responsive to the characterizing information comprised in the selected VP.

In an embodiment of the invention, wherein the instruction to the functionality or the response forwarded to the user is modified responsive to the characterizing information comprised in one or more non-selected VPs associated with the same user as the selected VP.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Descriptions of embodiments of the invention in the present application are provided by way of example and are not intended to limit the scope of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to persons of the art. The scope of the invention is limited only by the claims.

1. A method for a user to interact with a computer-based functionality as one of a plurality of virtual personas (“VPs”), the method comprising:
registering a user's selection of one VP out of a plurality of VPs associated with the user, each VP comprising characterizing information characterizing one of a plurality of aspects of the user, the selected VP being operable to be controlled by the user to configure an instruction to the functionality;
receive the instruction and forward the instruction to the functionality;
receive a response responsive to the instruction from the functionality; and
forward the response to the user.

2. The method according to claim 1, wherein the computer-based functionality is selected from the group consisting of an application, an API and a website.

3. The method according to claim 2, wherein the functionality comprises a search engine and the instruction comprises a query.

4. The method according to claim 3, wherein, the query is for identifying a VP of another user.

5. The method according to claim 4, further comprising initiating a computer-based communication with the other user of the identified VP.

6. The method according to claim 1 wherein other information relating to the user that is not comprised in the characterizing information of the selected VP is not accessible to the functionality.

7. The method according to claim 6 wherein other information relating to the user that is not comprised in the characterizing information of the selected VP is not accessible to another user.

8. The method according to claim 6, wherein the other information that is not accessible comprises an identity of the user and/or an identity of other VPs associated with the user.

9. The method according to claim 1, wherein the instruction to the functionality or the response forwarded to the user is modified responsive to the information relating to the user aspect comprised in the selected VP.

10. The method according to claim 1, wherein the instruction to the functionality or the response forwarded to the user is modified responsive to information relating to one or more non-selected VPs.

11. A computer system for a user to interact with a computer-based functionality as one of a plurality of virtual personas (“VPs”), the system comprising:
a first memory comprising a plurality of VPs, each VP comprising characterizing information that characterizes the VP;
a second memory comprising profiles of a plurality of users and association data associating each of the plurality of users with a VP of the plurality of VPs, such that each user is associated with a plurality of VPs and each VP is associated with one user; and
a processor operable to:
register a user's selection of one VP out the one or more VPs associated with the user, the selected VP being operable to be controlled by the user to configure an instruction to a functionality;
receive the instruction and forward the instruction to the functionality;
receive a response responsive to the instruction from the functionality; and
forward the response to the user.

12. The method according to claim 11, wherein the computer-based functionality is selected from the group consisting of an application, an API and a website.

13. The method according to claim 12, wherein the functionality is a search engine and the instruction is a query.

14. The method according to claim 13, wherein, the query is for identifying a VP associated with another user.

15. The method according to claim 14, wherein the processor is further operable to initiate a computer-based communication with the other user of the identified VP.

16. The method according to claim 11 wherein the user profiles are not accessible to the functionality.

17. The method according to claim 11 wherein the user profile of a given user is not accessible to another user.

18. The method according to claim 11, wherein the association data relating to a given user is not accessible to another user.

19. The method according to claim 11, wherein the instruction to the functionality or the response forwarded to the user is modified responsive to the characterizing information comprised in the selected VP.

20. The method according to claim 11, wherein the instruction to the functionality or the response forwarded to the user is modified responsive to the characterizing information comprised in one or more non-selected VPs associated with the same user as the selected VP.
